(19) United States
(12) Patent Application Publication
(10) Pub. No.: US 2013/0223853 A1
(43) Pub. Date: Aug. 29, 2013

(54) CARTRIDGE

(71) Applicant: CANON KABUSHIKI KAISHA, (US)

(72) Inventors: Kazuo Chadani, Suntou-gun (JP); Hideki Kakuta, Suntou-gun (JP); Masato Tanabe, Susono-shi (JP)

(73) Assignee: CANON KABUSHIKI KAISHA, Tokyo (JP)

(21) Appl. No.: 13/768,256

(22) Filed: Feb. 15, 2013

(30) Foreign Application Priority Data
Feb. 23, 2012 (JP) 2012-037699

(51) Int. Cl. G03G 15/00

(52) U.S. Cl. CPC G03G 21/1896
USPC 399/12

(57) ABSTRACT

A cartridge detachably mountable to a main assembly of a color image forming apparatus for forming a color image on a recording material, the cartridge includes: a frame for accommodating a developer; and a discriminating member molded of a material having a similar color to a color of the developer. The discriminating member is marked with discriminating information for discriminating the cartridge.

### FIELD OF THE INVENTION AND RELATED ART

The present invention relates to a cartridge detachably mountable to an apparatus main assembly of an image forming apparatus for forming an image on a recording material (medium).

The image forming apparatus forms the image on the recording material by using an image forming process of, e.g., an electrophotographic image formation type, an electrostatic recording image formation type, a magnetic recording image formation type, or the like. For example, the image forming apparatus may include a copying machine, a printer (laser beam printer, LED printer, etc.), a facsimile machine, a multi-function machines having functions of these machines, and a word processor, and so on.

The recording material is a material on which the image is to be formed and includes, e.g., paper, OHT sheet, and the like. An intermediary transfer member, an image displaying member of an image display apparatus, and the like are also included in the recording material.

The cartridge is, e.g., a process cartridge or a developing cartridge and contributes to an image forming process for forming the image on the recording material in a state in which the cartridge is detachably mounted in an apparatus main assembly of the image forming apparatus. The apparatus main assembly of the image forming apparatus is an apparatus constituent portion obtained by removing the cartridge from a constitution of the image forming apparatus.

The process cartridge is prepared by integrally assembling a rotatable image bearing member on which a latent image is to be formed, and at least one of a charging means, a developing means, a cleaning means and the like as an image forming process means acting on the image bearing member into a cartridge. Then, the process cartridge is detachably mounted into the apparatus main assembly. The image bearing member is an electrophotographic photosensitive member of an electrophotographic image forming type, an electrostatic recording dielectric member of an electrostatic recording image forming type, a magnetic recording (magnetic) member of a magnetic recording image forming type, and the like.

Therefore, the process cartridge includes a cartridge which is prepared by integrally assembling the image bearing member and the developing means as the image forming process means into a unit (cartridge) and which is detachably mountable to the apparatus main assembly. The process cartridge integrally includes the image bearing member and the developing means is referred to as a so-called integral type. Further, a process cartridge integrally including the image bearing member and the process means other than the developing means is referred to as a so-called function-separation type. That is, the developing means is provided in a developing unit other than the process cartridge, and a process cartridge for forming the image by being paired with the developing unit is referred to as the so-called function-separation type.

Further, the developing cartridge includes a developer carrying member (developing roller) for applying a developer to the image bearing member and accommodates the developer (toner) used for developing the latent image, by the developer carrying member, formed on the image bearing member, and is detachably mounted into the apparatus main assembly.

In the case of the developing cartridge, the image bearing member is mounted to the apparatus main assembly or a cartridge supporting member. Alternatively, the image bearing member is provided in the so-called function-separation type process cartridge. In this case, the process cartridge does not includes the developing means.

The cartridge includes the so-called integral type contact and the so-called function-separation type process cartridge. Further, the cartridge includes the case where the so-called function-separation type process cartridge and the developing cartridge are used in a pair. Further, the cartridge includes the case where the image bearing member is fixedly mounted to the apparatus main assembly or the cartridge supporting member and the developing cartridge is used so as to be actable on the image bearing member and be detachably mountable the apparatus main assembly or the cartridge supporting member. Further, the cartridge includes a developer cartridge which accommodates the developer (toner) to be supplied to the process cartridge, the developing cartridge, or the like.

According to the cartridge type, an operator (user) can perform a maintenance of the image forming apparatus by himself (herself) without relying on a service person. For that reason, the cartridge type has been widely used in the image forming apparatus represented by an electrophotographic type.

Further, in a color electrophotographic image forming apparatus, a plurality of process cartridges, developing cartridges or developer cartridges which meet a plurality of colors and which are different in color of the developer, are detachably mountable to the apparatus main assembly of the image forming apparatus. In this case, with respect to each of the cartridges of the respective colors, there was a need to prevent the cartridge from being erroneously mounted to a mounting portion different from a corresponding predetermined cartridge mounting portion in an apparatus main assembly side.

The present applicant had proposed a constitution in which mutually discriminating labels are applied to cartridges different in color (Japanese Laid-Open Patent Application (JP-A) 2003-195728). In this case, the labels to be applied to the cartridges are supplied as a roll material during assembling of the cartridges in many instances. For that reason, in the case where there are a plurality of colors and a plurality of destinations or in the like case, roll members of various labels for these colors or destinations are prepared and stored in advance. Further, in the case where a roll material exchanging operation is performed every destination, an assembly line is temporarily stopped during assembling of the cartridge.

### SUMMARY OF THE INVENTION

The present invention is a further development of the above-described conventional constitution. A principal object of the present invention is to provide a cartridge having a cartridge discriminating constitution capable of reducing a manufacturing cost without requiring a roll of a preprinted discriminating member such as a label to eliminate a need to perform a roll exchanging operation or to ensure a storage space.

According to an aspect of the present invention, there is provided a cartridge detachably mountable to a main assembly of a color image forming apparatus for forming a color image on a recording material, the cartridge comprising: a frame for accommodating a developer; and a discriminating member molded of a material having a similar color to a color of the developer, wherein the discriminating member is marked with discriminating information for discriminating the cartridge.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a perspective view of a principal part of a drum unit in a process cartridge in an embodiment.

FIG. 2 is a general structural view of a color electrophotographic image forming apparatus in the embodiment.

FIG. 3 is a sectional view of the process cartridge in the embodiment.

FIG. 4 is a perspective view of the process cartridge.

FIG. 5 is a perspective view of a developing unit in the process cartridge.

FIG. 6 is a perspective view of the drum unit in the process cartridge.

FIG. 7 is a perspective view of a principal part of the process cartridge before a discriminating member is assembled with the drum unit.

FIG. 8 is a perspective view of a principal part of the process cartridge after the discriminating member is assembled with the drum unit.

FIG. 9 is an illustration of another assembling form of the discriminating member with respect to the drum unit.

FIG. 10 is an illustration of a manner of mounting a process cartridge into an apparatus main assembly.

### DESCRIPTION OF THE PREFERRED EMBODIMENTS

Hereinbelow, embodiments for carrying out the present invention will be exemplarily and specifically described with reference to the drawings. However to dimensions, materials, shapes, relative arrangements and the like of constituent elements described in the following embodiments, the scope of the present invention is not limited unless otherwise specified.

### First Embodiment

### Schematic Structure of Image Forming Apparatus

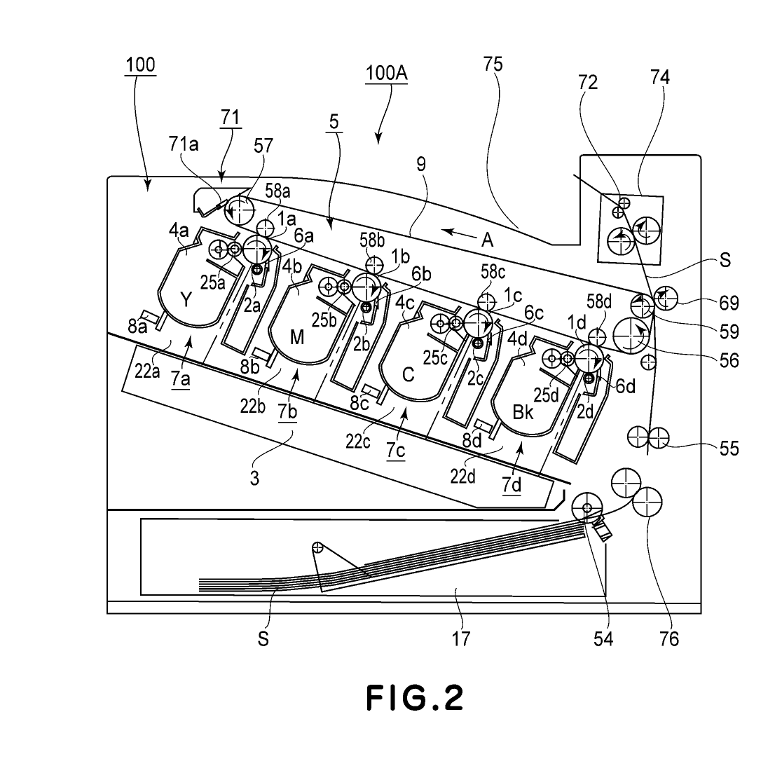

With reference to FIG. 2, a schematic structure of an image forming apparatus 100A according to this embodiment will be described. The image forming apparatus 100A according to this embodiment is a full-color laser beam printer (color image forming apparatus) employing an electrophotographic image forming type. On the basis of image information (electrical image signal) inputted from an external host device (not shown) into a control circuit portion (not shown), an image is formed on a sheet material (recording material) S as a recording medium. The external host device is a personal computer, an image reader, a facsimile machine, a network, and the like.

The color image forming apparatus 100 according to this embodiment is an apparatus of an intermediary transfer type and a cartridge type, in which four process cartridges 7 (7a, 7b, 7c, 7d) are provided in an apparatus main assembly 100. The respective process cartridges 7 are successively disposed and inclined diagonally right down with respect to the horizontal direction from left to right. The process cartridges 7 (7a, 7b, 7c, 7d) are detachably mounted to associated predetermined cartridge mounting portions 22 (22a, 22b, 22c, 22d), respectively, in the apparatus main assembly 100.

The four process cartridges 7 have the same constitution except that only colors of developers (toners) accommodated therein are different from each other. In this embodiment, a toner of yellow (Y) is accommodated in the process cartridge 7a, and a toner of magenta (M) is accommodated in the process cartridge 7b. A toner of cyan (C) is accommodated in the process cartridge 7c, and a toner of black (K) is accommodated in the process cartridge 7d.

In each process cartridge 7, an electrophotographic photosensitive drum 1 (1a, 1b, 1c, 1d) as a rotatable image bearing member on which a latent image is to be formed is provided. Further, around the photosensitive drum 1, as image forming means acting on the photosensitive drum 1, a charging roller 2 (2a, 2b, 2c, 2d), a developing roller 25 (25a, 25b, 25c, 25d) and a cleaning member 6 (6a, 6b, 6c, 6d) are provided.

The charging roller 2 is a charging means for electrically charging the surface of the photosensitive drum 1 uniformly. The developing roller 25 is a developing means (developer carrying member) for developing an electrostatic latent image, formed on the photosensitive drum 1, with a toner to visualize the electrostatic latent image. Further, the cleaning member 6 is a cleaning means for removing the toner remaining on the surface of the photosensitive drum 1 after a toner image (developer image) formed on the photosensitive drum 1 is transferred onto an intermediary transfer means.

Below each of the process cartridges 7, a scanner unit 3 (exposure unit) for forming the electrostatic latent image on the surface of the photosensitive drum 1 by irradiating the surface of the photosensitive drum 1 with exposure light (laser light) on the basis of image information is provided. As a result, the surface of the photosensitive drum 1 is selectively exposed to light.

At a lower portion of the inside of the image forming apparatus 100A, a cassette 17 in which sheet material S is accommodated is mounted. Further, in connection with the cassette 17, a conveying path is provided so that the recording material S can be conveyed to an upper portion of the image forming apparatus 100A by being passed through a secondary transfer roller 69 and a fixing portion 74. Along the conveying path, conveying means 54, 76 and 55 such as belt pairs are provided. Specifically, a feeding roller 54 for separating and feeding the sheets of the sheet material S from the cassette 17 in a one-by-one manner, a conveying roller pair 76 for conveying the fed sheet material S, and a registration roller pair 55 for synchronizing the electrostatic latent image formed on the photosensitive drum 1 with the sheet material S are provided.

On each of the process cartridges 7, an intermediary transfer unit 5 as an intermediary transfer means onto which the toner image formed on the surface of the photosensitive drum 1 is to be transferred is provided. Inside the intermediary transfer unit 5, a driving roller 56, a follower roller 57, primary transfer rollers 58 (58a, 58b, 58c, 58d) opposing the photosensitive drums 1, respectively, and an opposite roller 59 disposed opposed to a secondary transfer roller 69 are provided. Around these roller members, a transfer belt 9 as an intermediary transfer belt is extended and stretched rotatably in the counterclockwise direction indicated by an arrow A.

The transfer belt 9 opposes all of the photosensitive drums 1 and is circulated and moved so as to be contacted to the photosensitive drums 1. Then, a voltage is applied to the primary transfer roller 58, so that the toner image is primary-transferred from the photosensitive drum 1 onto the transfer belt 9. Further, at a nip (secondary transfer portion) between the opposite roller 59 and the secondary transfer roller 69, the toner image is secondary-transferred from the transfer belt 9 onto the sheet material S.

When the image is formed on the sheet material S, the transfer belt 9 is rotationally driven in the counterclockwise direction of the arrow A. Further, each photosensitive drum 1 is rotated in the clockwise direction of the arrow. A rotational speed of each photosensitive drum 1 corresponds to that of the transfer belt 9, and the rotational direction of each photosensitive drum 1 is the same as that of the transfer belt 9 at a contact portion (primary transfer portion) where the photosensitive drum 1 contacts the transfer belt 9. Further, the photosensitive drum 1 uniformly charged by the charging roller 2 is subjected to selective exposure to light (scanning exposure to laser light) by the scanner unit 3. As a result, to the electrostatic latent image formed on the photosensitive drum 1, the toner is electrostatically supplied from the developing roller 25, so that the electrostatic latent image is visualized as the toner image.

By such an electrophotographic image forming process operation, on the photosensitive drum 1a of the process cartridge 7a, a Y toner image corresponding to a yellow component of a full-color image is formed. The toner image is primary-transferred onto the transfer belt 9. Similarly, on the photosensitive drum 1b of the process cartridge 7c, an M toner image corresponding to a magenta component of the full-color image is formed. The toner image is primary-transferred superposedly onto the Y toner image which has already been formed on the transfer belt 9.

Similarly, on the photosensitive drum 1c of the process cartridge 7c, a C toner image corresponding to a cyan component of the full-color image is formed. The toner image is primary-transferred superposedly onto the Y and M toner images which have already been formed on the transfer belt 9. Similarly, on the photosensitive drum 1d of the process cartridge 7d, a K toner image corresponding to a black component of the full-color image is formed. The toner image is primary-transferred superposedly onto the Y, M and C toner images which have already been transferred on the transfer belt 9.

In this way, a full-color unfixed toner image of four colors of Y, M, C and K is formed on the transfer belt 9.

Further, in synchronism with the toner image formation, the sheet material S is conveyed by the registration roller pair 55 to a secondary transfer position which is a nip between the opposite roller 59 and the secondary transfer roller 69 and at which the transfer belt 9 interposed between the rollers 59 and 69.

At the secondary transfer position, a predetermined transfer voltage is applied to the secondary transfer roller 69, so that the superposed respective color toner images are secondary-transferred collectively from the transfer belt 9 onto the sheet material S. As a result, an unfixed color toner image is formed on the sheet material S.

The sheet material S on which the color image is formed is heated and pressed at the fixing portion 74, so that the toner image is fixed on the sheet material S. Thereafter, the sheet material S is discharged onto a discharge portion 75 by a (sheet-)discharging roller 72. Incidentally, after the secondary transfer, the toner which has not completely transferred onto the sheet material S remains on the transfer belt 9 in some cases. Therefore, in this embodiment, a transfer belt cleaning device 71 including a toner collecting container 71a is provided.

### (Schematic Structure of Process Cartridge)

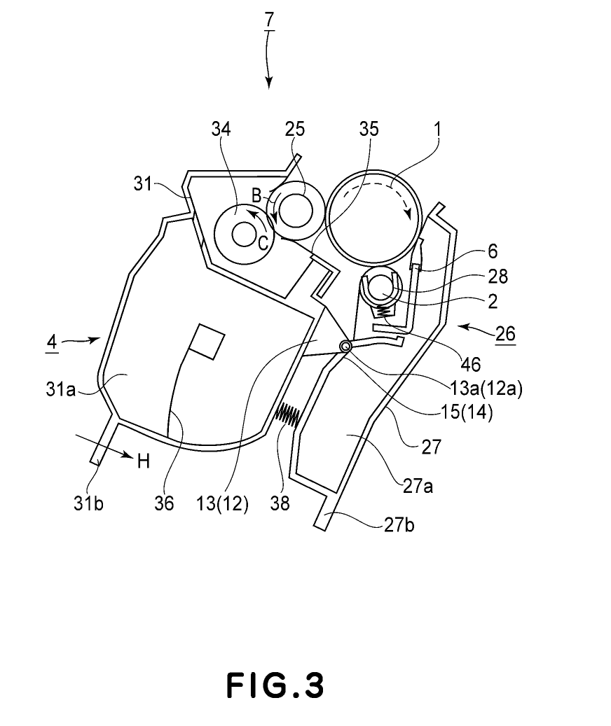

With reference to FIGS. 3, 4 and 5, a schematic structure of the process cartridge 7 will be described. Incidentally, in this embodiment, the four process cartridges 7 (7a, 7b, 7c, 7d) are provided for the toner colors, respectively, but all of constitutions of these process cartridges 7 are the same. Therefore, in this embodiment, one process cartridge is described and other process cartridges will be omitted from description.

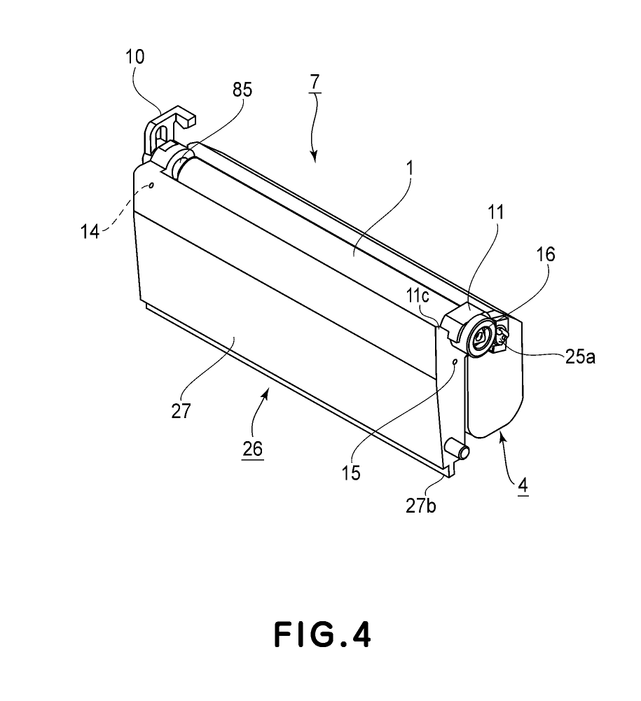

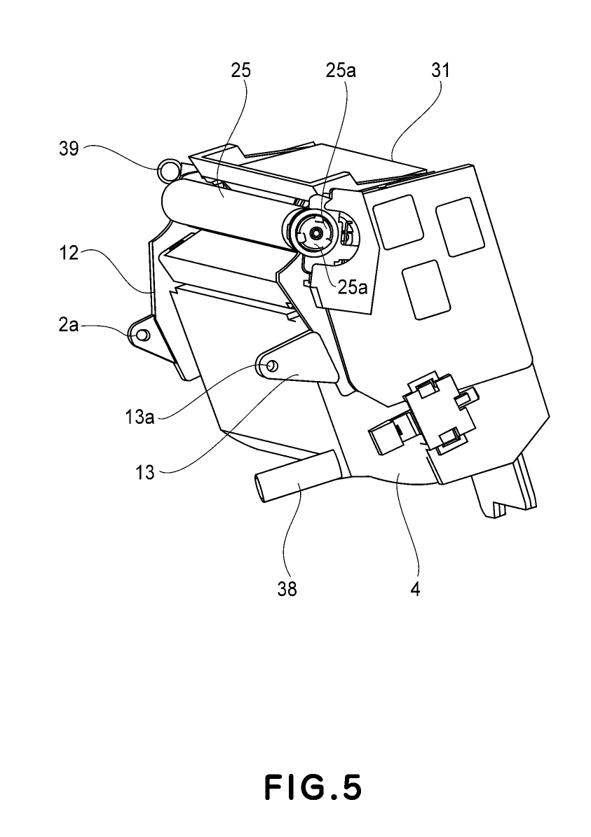

FIG. 3 is a principal sectional view of the process cartridge 7 in which the toner is accommodated. FIG. 4 is a perspective view of an outer appearance of the process cartridge 7. The process cartridge 7 includes a drum unit 26 (26Y, 26M, 26C, 26K) and a developing unit (developing device) 4 (4Y, 4M, 4C, 4K). The drum unit 26 includes the photosensitive drum 1, the charging roller 2 and the cleaning member 6. Further, the developing unit 4 includes the developing roller 25. FIG. 5 is a perspective view of an outer appearance of the developing unit 4.

To a cleaning (device) frame 27 (for accommodating the developer) of the drum unit 26, the photosensitive drum 1 is mounted rotatably via a front drum bearing 10 and a rear drum bearing 11 (FIG. 4). Then, the photosensitive drum 1 is rotationally driven by transmission of a driving force from an unshown main assembly (side) driving motor.

Here, with respect to the process cartridge 7, a longitudinal direction is a rotational axis direction of the photosensitive drum 1, and an end portion side with respect to the longitudinal direction is a front side and another portion side with respect to the longitudinal direction is a rear side. Further, in this embodiment, the rear side is a driving side, and the front side is a non-driving side.

A flange 85 and a drum coupling 16 are provided at a front-side end portion and a rear-side end portion, respectively, of the photosensitive drum 1. Further, the cleaning member 6 is provided so as to contact the surface of the photosensitive drum 1. By such a constitution, a residual toner removed from the surface of the photosensitive drum 1 drops into a removed toner chamber 27a. Further, the charging roller 2 is rotatably mounted to the cleaning frame 27 via a charging roller bearing 28 at each of its front-side end portion and its rear-side end portion. Further, the charging roller 2 is urged toward the photosensitive drum 1 by a charging roller urging member 46, thus being rotated by the rotation of the photosensitive drum 1.

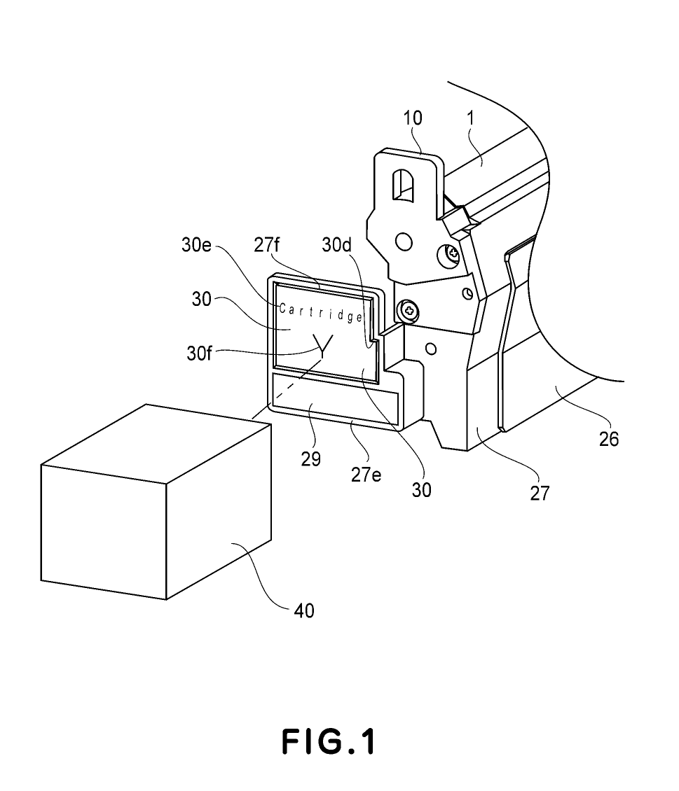

The developing unit 4 includes the developing roller 25, rotated in contact with the photosensitive drum 1 in an arrow B direction shown in FIG. 1 and a developing (device) frame 31 for supporting the developing roller 25. The developing roller 25 is rotatably supported by the developing frame 31 via a front developing (roller) bearing 12 and a rear developing (roller) bearing 13 provided at the front-side end portion and the rear-side end portion of the developing frame 31, respectively (FIG. 5). At the rear-side end portion of the developing roller 25, a developing (roller) coupling 25a is provided.

Further, on the peripheral surface of the developing roller 25, a toner supplying roller 34 which is contacted to the developing roller 25 and is rotated in an arrow C direction in FIG. 3, and a developing blade 35 for regulating a toner layer on the developing roller 25 are provided.

Further, at a toner accommodating portion (developer accommodating portion) 31a of the developing frame 31, a toner feeding member 36 for feeding the toner toward the toner supplying roller 34 while stirring the toner accommodated in the toner accommodating portion 31a is provided.

To the process cartridge 7 in this embodiment, the developing unit 4 is mounted movably (rotationally movably) relative to the drum unit 26 so that the developing roller 25 is contactable to and separable from the surface of the photosensitive drum 6. That is, the developing frame 31 is provided with the front developing bearing 12 and the rear developing bearing 13 in which hanging holes 12a and 13a are formed, respectively.

With these hanging holes 12a and 13a, a front shaft member 14 and a rear shaft member 15 are engaged. As a result, the developing unit 4 is movably supported by the drum unit 26 with the front shaft member 14 and the rear shaft member 15 as a rotation shaft (FIG. 3).

Further, the cleaning frame 27 is provided with a front drum bearing 10 and a rear drum bearing 11 which rotatably support the photosensitive drum 1. The rear drum bearing 11 supports a drum coupling 16 to be coupled to the photosensitive drum 1. Further, the front drum bearing 10 supports a flange 85. The drum coupling 16 is a drum coupling member for transmitting a driving force from an apparatus main assembly side of the image forming apparatus 100A to the photosensitive drum 1.

As shown in FIG. 5, the developing frame 31 includes an urging spring 38 and a tension spring 39 provided to the front developing bearing 12, and by these urging means, the developing unit 4 can be moved in a direction toward the drum unit 26 and its opposite direction. Further, as described later, during image formation, the developing unit 4 is moved so that the developing roller 25 contacts the surface of the photosensitive drum 1. During non-image formation, the developing unit 4 is moved so that the developing roller 25 is separated (spaced) from the surface of the photosensitive drum 1.

Incidentally, in a contact developing system in which the photosensitive drum 1 and the developing roller 25 contact to effect development, it is preferable that the photosensitive drum 1 is a rigid member and the developing roller 25 is a roller including an elastic member. As the elastic member used in this embodiment, a solid rubber single layer, a solid rubber layer subjected to resin coating in view of a charge imparting property to the toner, and the like layer are used.

Next, a series of operations regarding the image formation of the process cartridge 7 will be described (FIGS. 2 and 3). When image information is sent to the control circuit portion of the image forming apparatus 100, the main assembly driving motor (not shown) starts rotation, so that a driving rotational force is transmitted to the photosensitive drum 1, the developing roller 25, the toner supplying roller 34 and the toner feeding member 36. Then, to the charging roller 2, the charging bias voltage is applied, so that the surface of the photosensitive drum 1 is electrically charged uniformly. Then, depending on the image information, the scanning exposure with the laser light emitted from the scanner unit is effected, so that the latent image is formed on the photosensitive drum 1.

Then, the toner in the toner accommodating portion 31a is sent to the toner supplying roller 34 by the rotation of the toner feeding member 36. Then, to the toner supplying roller 34, the bias voltage is applied. The toner supplying roller 34 is rotated to supply the toner onto the outer peripheral surface of the rotating developing roller 25. The toner supplied to the outer peripheral surface of the developing roller 25 is triboelectrically charged at the outer peripheral surface of the developing roller 25 by the developing blade 35 to which the bias voltage is applied. Then, to the developing roller 25, the bias voltage is applied.

As a result, the electrostatic latent image formed on the photosensitive drum 1 is developed. Incidentally, the developing roller 25 is disposed opposed to the photosensitive drum 1. Further, the developing roller 25 has a constitution in which it contacts the photosensitive drum 1 and develops the electrostatic latent image formed on the photosensitive drum 1.

### (Explanation of Discriminating Portion of Process Cartridge)

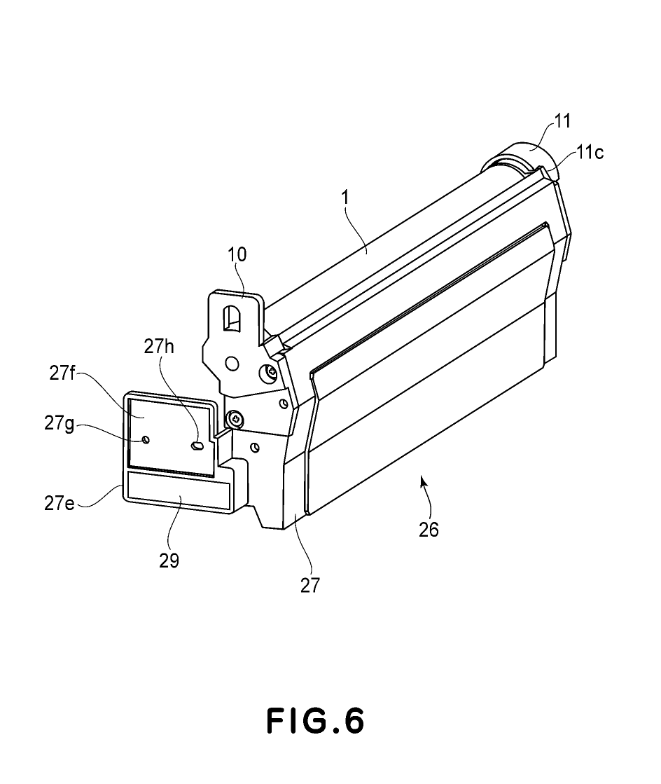

A discriminating portion of the process cartridge 7 will be described. As shown in FIG. 6, in the front side of the cleaning frame 27 of the drum unit 26, a grip portion 27e as an operating portion to be operated by a user when the process cartridge 7 is mounted to the cartridge mounting portion 22 of the apparatus main assembly 100 is provided.

To the grip portion 27e, an operation display portion 29 for indicating that its location is the operating portion is provided. The operation display portion 29 is a resin material colored blue and is formed on the cleaning frame 27 by two-color molding. In this embodiment, an example in which the operation display portion 29 is formed by the two-color molding is shown but a method of forming the operation display portion 29 is not limited thereto but may also be a method in which the operation display portion 29 is provided as a separate member and is applied onto the cleaning frame 27 by welding or double-side tape.

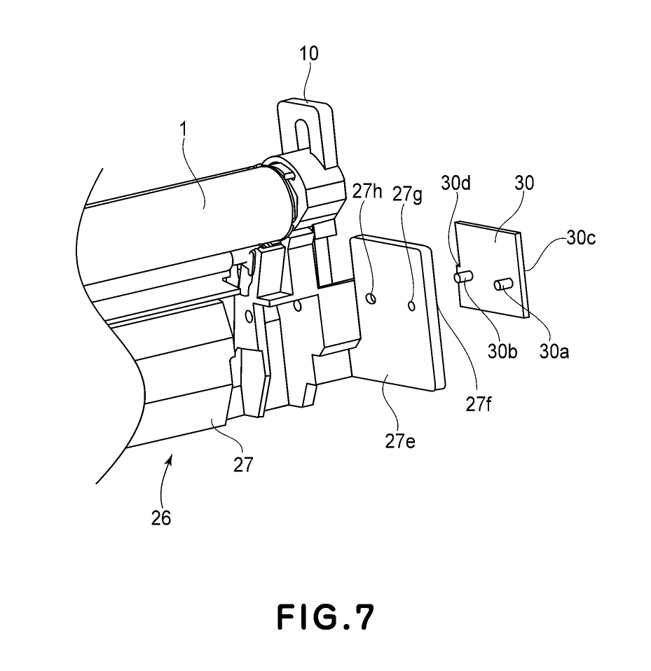

Further, the grip portion 27e is provided with a mounting portion 27f for mounting a discriminating member 30 (FIG. 7) for discriminating the color of the process cartridge 8 (color of the developer accommodated in the cartridge). The mounting portion 27f is provided with a positioning hole 27g and an elongated positioning hole 27h into which a positioning boss 30a and a rotation preventing boss 30b of the discriminating member 30 are to be inserted, respectively.

As shown in FIG. 7, the discriminating member 30 (marking member) having a plate shape is provided with marking portion (markable surface) 30c for marking (displaying) discrimination information (information on the cartridge) for discriminating the associated process cartridge 7. Further, the positioning boss 3a and the rotation preventing boss 30b for mounting the discriminating member 30 on the cleaning frame 27 are provided at an opposite surface (in an opposite side of the marking surface) from the marking portion 30c.

Further, the discriminating member 30 is provided with a direction discriminating portion 30d for discriminating an up-down direction when parts are fed by a parts feeder during assembling. By using the direction discriminating portion 30d, the up-down direction is discriminated in a step to perform assembling. The discriminating member 30 is molded with a resin material of a color (similar to the color of the developer accommodated in the cartridge) indicating the toner color of the contact 7. For example, the discriminating member 30 is molded with the material such as PS or ABS.

In this way, the discriminating member 30 is molded with the material of similar color to the toner color of the process cartridge 7, so that it becomes possible to improve productivity of the process cartridge 7 and to easily discriminate the color of the toner accommodated in the process cartridge.

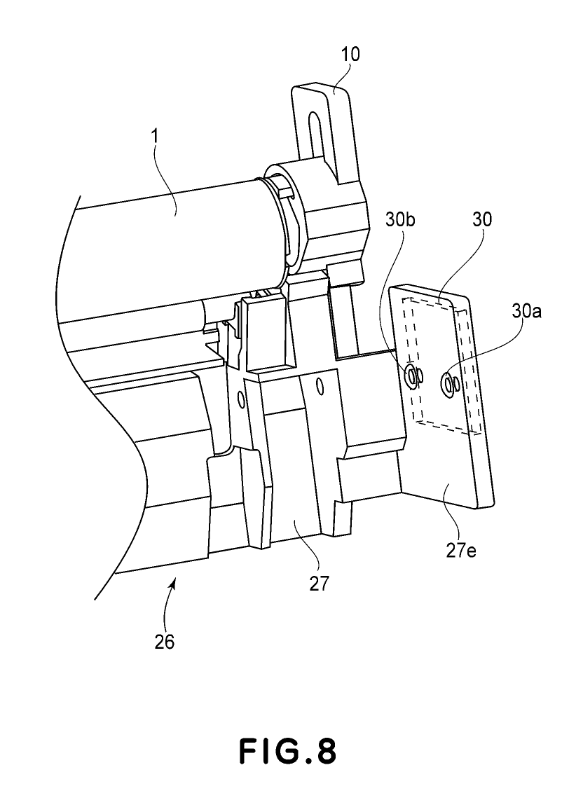

As shown in FIG. 8, after the discriminating member 30 is mounted on the mounting portion 27f, the positioning boss 30a and the rotation preventing boss 30b are subjected to thermal caulking to effect retention. In this embodiment, the description is made by using the thermal caulking but the present invention is not limited thereto. Another retaining constitution such as press fitting and snap-fitting may also be used. Further, the discriminating member 30 may also be ultrasonic-welded on the mounting portion 27f.

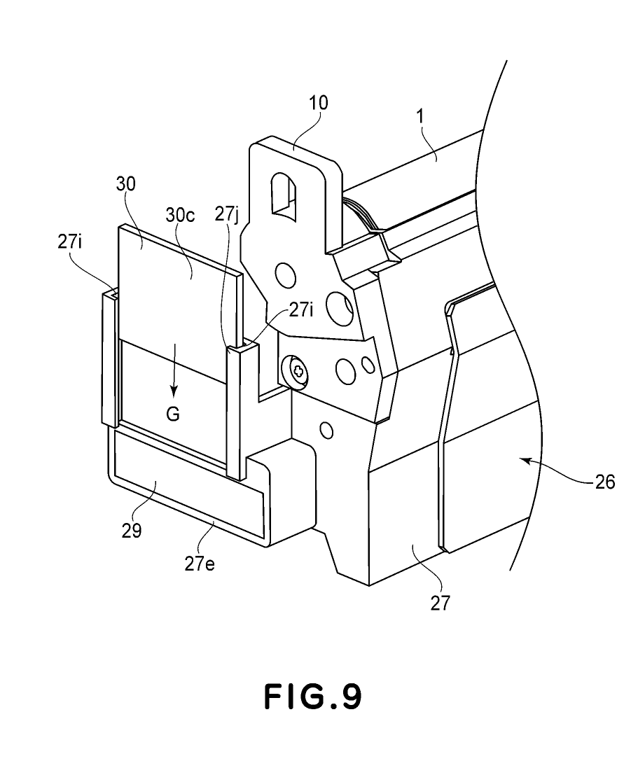

Further, as shown in FIG. 9, the discriminating member 30 is inserted into a slit 27i provided in the cleaning frame 27 (arrow G direction) and then a slit entrance portion 27j of the cleaning frame 27 is subjected to the thermal caulking to put a lid as a retaining portion. Further, in place of the thermal caulking, a constitution in which the discriminating member 30 is covered with a lid using a separate member (not shown).

Further, as shown in FIG. 1, after the discriminating member 30 is mounted on the mounting portion 27f of the cleaning frame 27, inscription is made at the marking portion 30c of the discriminating member 30 by using a laser maker (marking device) 40. That is, the inscription on the discriminating member 30 is made during assembling of the cartridge.

The discrimination information to be marked is information on the associated cartridge 7 and, e.g., a display 30e of “Cartridge” indicating the process cartridge 7, a display 30f of, e.g., icon “Y” for yellow indicating the toner color of the contact 7 (7a), and the like. Further, a bar code or QR code indicating a product number of the process cartridge may also be marked for display.

In this embodiment, as the marking device 40, the laser marker was used for description but a marking device using ink jet may also be used. Further, the marking portion 30c of the discriminating member 30 may also be subjected to surface processing (e.g., graining processing or glossing processing) so that the marking portion can be easy to see when the inscription is made. By selecting a surface property of the marking portion 30c by a marking method (e.g., laser inscription or ink jet inscription), discrimination of the inscription can be made easier. Further, the inscription on the discriminating member 30 is performed in an assembling step before the discriminating member 30 is mounted on the cleaning frame 27, and thereafter the discriminating member 30 may also be mounted by a mounting means such as the above-described thermal caulking.

With respect to the discrimination information to be discriminated, information such as color or destination is registered in the marking device 40 in advance and then the discrimination information is simply switched depending on the destination or the color, so that an operation for replacing a roll depending on the destination can be reduced.

(Mounting Mechanism of Process Cartridge 7 into Apparatus Main Assembly 100)

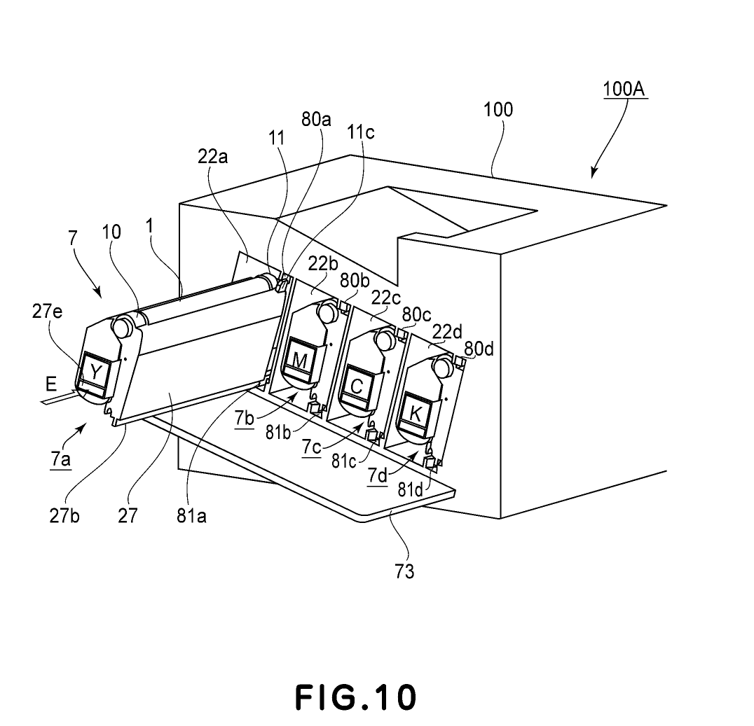

Next, a mounting mechanism for mounting the process cartridge 7 in a corresponding predetermined cartridge mounting portion 22 in the apparatus main assembly 100 side will be described with reference to FIG. 10. In a front side of the apparatus main assembly 100, an openable front cover 73 is provided. When the front cover 73 is opened, four cartridge mounting portions 22 (22a to 22d) juxtaposed obliquely with respect to the horizontal direction are exposed. At a front surface portion of each cartridge mounting portion 22, a main assembly-side discriminating portion (not shown) where the color of the process cartridge 7 to be mounted is displayed is provided, and when the front cover 73 is opened, the main assembly-side discriminating portion can be easily recognized.

In upper and lower sides of each mounting portion 22, an upper mounting guide 80 (80a to 80d) as a first main assembly-side guide and a lower mounting guide 81 (81a to 81d) as a second main assembly-side guide are provided, respectively, so as to extend from the front side to the rear side of the apparatus main assembly 100.

The mounting of the process cartridge 7 into the apparatus main assembly 100 is made as follows. The front surface of each cartridge mounting portion 22 is opened by opening the front cover 73. Then, the color of the process cartridge 7 to be mounted is checked by the discriminating member 30 and then a rear end portion of the associated process cartridge 7 (7a) is inserted into the apparatus main assembly 100 through a front surface opening of the cartridge mounting portion 22 where the main assembly-side discriminating portion corresponding to the checked color is provided.

In this case, the upper guide portion 11c provided on a rear drum bearing 11 of the cleaning frame 27 of the process cartridge 7 (7a) is engaged with the upper mounting guide 80 of the apparatus main assembly 100. Similarly, the lower guide portion 27b provided to the drum unit 26 is engaged with the lower mounting guide 81 of the apparatus main assembly 100.

Then, the grip portion 27e located in the front side of the cleaning frame 27 is pushed an arrow E direction in FIG. 10 to sufficiently insert the process cartridge 7 (7a) toward the rear side of the apparatus main assembly 100 along the upper mounting guide 80 and the lower mounting guide 81 until the process cartridge 7 (7a) abuts against a stopper (not shown). As a result, an insertion mounting of the process cartridge 7 (7a) into the apparatus main assembly 100 is completed. Also with respect to the process cartridges 7 for other colors, in the same manner as described above, the process cartridges 7 are inserted and mounted into the cartridge mounting portions 22 where the main assembly-side discriminating portions corresponding to the associated colors are provided. Thereafter, the front cover 73 is closed to cover the front surface of the apparatus main assembly 100.

By a mechanism (not shown) interrelated with the closing of the front cover 73, the drum unit 26 of the process cartridge 7 inserted and mounted in the associated cartridge mounting portion 22 is pressed and positionally fixed at a positioning portion in the apparatus main assembly side. A drive outputting coupling (not shown) in the apparatus main assembly 100 side is operated so as to be connected with the drum coupling 16 and the developing coupling 25a of each process cartridge 7. A bias application electric contact (not shown) in the apparatus main assembly 100 side is placed in an electrically conducted state with an electric contact (not shown) in the process cartridge 7 side. As a result, each process cartridge 7 is placed in an image forming operation enable state.

Here, during non-image formation of the image forming apparatus 100A, the developing unit 4 of each process cartridge 7 is rotationally moved about the front shaft member 14 and the rear shaft member 15 relative to the drum unit 26 in a direction in which the developing roller 25 is kept in a spaced state from the photosensitive drum 1. The rotational movement of the developing unit 4 is performed by urging a pressure-receiving portion 31a of the developing frame 31 in the arrow H direction (FIG. 3) against a spring force of the urging spring 38 and the tension spring 39 by an urging mechanism (not shown) in the apparatus main assembly 100 side.

During the image formation, the urging at the pressure-receiving portion 31a by the urging mechanism is eliminated. As a result, the developing unit 4 is rotationally moved back to the original position by the spring force of the urging spring 38 and the tension spring 39, so that the developing roller 25 is placed in a contact state with the photosensitive drum 1 at a predetermined urging force.

Demounting of each process cartridge 7 from the apparatus main assembly 100 is performed in an opposite procedure to the procedure in the case of the above-described insertion mounting. That is, when the front cover 73 is opened, the positional fixation of each process cartridge 7 to the apparatus main assembly 100 is eliminated. Further, the connection of the drive outputting coupling of the apparatus main assembly 100 with the drum coupling 16 and the developing coupling 25a is eliminated. Further, the electric conduction of the bias application electric contact of the apparatus main assembly 100 with the electric contact of the process cartridge 7 is also eliminated.

Then, the grip portion 27e of the cleaning frame 27 is pulled in a direction opposite to the arrow E direction (FIG. 10), so that the process cartridge 7 can be demounted from the apparatus main assembly 100.

Here, the grip portion 27e of the cleaning frame 27 is disposed in a direction perpendicular to a direction (arrow E) in which the process cartridge 7 is to be mounted. That is, the marking portion 30c which is a markable surface of the discriminating member 30 is provided at a surface perpendicular to the direction in which the process cartridge 7 is to be mounted into the apparatus main assembly 100. This is because by providing the grip portion 27e in the direction perpendicular to the mounting direction of the process cartridge 7, the discrimination of the discriminating member 30 becomes easy by the user when the process cartridge 7a is mounted into the apparatus main assembly 100.

In the above, the discriminating member 30 is described as being provided in the direction perpendicular to the mounting direction of the process cartridge 7 into the apparatus main assembly 100 but is not limited thereto. By disposing the process cartridge 7 in an upstream side of the mounting direction of the process cartridge 7, the user can mount the process cartridge 7 while recognizing the discriminating member 30, so that the discrimination of the discriminating member 30 becomes easy.

Further, the discriminating member 30 is provided at the grip portion 27e which is the operating portion when the user operates the process cartridge 7, thus leading to improve rigidity of the grip portion 27e since the grip portion 27e and the discriminating member 30 are integrally connected. That is, when the user operates the grip portion 27e, a degree of deformation of the grip portion 27e can be reduced and thus usability is improved.

In this embodiment, the constitution in which the process cartridge 7 is mounted into the apparatus main assembly 100 with respect to the longitudinal direction of the photosensitive drum 1 was described. However, the present invention is not limited to this constitution, and a constitution in which the discriminating portion is provided in the neighborhood of the grip portion of a process cartridge to be mounted into the apparatus main assembly with respect to a widthwise direction of the photosensitive drum 1 may also be employed.

### Other Embodiments

(1) In the above embodiment, although the example in which the cartridge detachably mountable to the cartridge mounting portion of the apparatus main assembly of the image forming apparatus for forming the image on the recording material is the process cartridge is described, the cartridge may also be the developing cartridge. Further, the cartridge may also be the developer cartridge. Further, the process cartridge is not limited to that of the so-called integral type but may also be that of the so-called function separation type. That is, the discriminating member on which the discrimination information for discriminating the cartridge is marked is provided to the cartridge including the frame for accommodating the developer, so that an effect similar to that of First Embodiment can be obtained. For example, the discriminating member of a similar color to the color of the developer accommodated in the developing frame 31 may also be provided on the developing frame 31.

(2) The image forming apparatus is not limited to that of the electrophotographic image forming type using the electrophotographic photosensitive member as the image bearing member. For example, the image forming apparatus may also be an image forming apparatus of an electrostatic recording image forming type using an electrostatic recording dielectric member as the image bearing member and an image forming apparatus of a magnetic recording image forming type using a magnetic recording (magnetic) member as the image bearing member. Further, the image forming apparatus is not limited to that of the intermediary transfer type. The image forming apparatus may also be that of a type in which the developer image formed on the image bearing member is directly transferred onto the recording material S.

While the invention has been described with reference to the structures disclosed herein, it is not confined to the details set forth and this application is intended to cover such modifications or changes as may come within the purpose of the improvements or the scope of the following claims.

This application claims priority from Japanese Patent Application No. 037699/2012 filed Feb. 23, 2012, which is hereby incorporated by reference.

What is claimed is:

1. A cartridge detachably mountable to a main assembly of a color image forming apparatus for forming a color image on a recording material, said cartridge comprising:
a frame for accommodating a developer; and
a discriminating member molded of a material having a similar color to a color of the developer, wherein said discriminating member is marked with discriminating information for discriminating said cartridge.

2. A cartridge according to claim 1, wherein the discriminating information is information indicating the color of said cartridge.

3. A cartridge according to claim 1, wherein the discriminating information is information indicating a destination of said cartridge.

4. A cartridge according to claim 1, wherein the material is a resin material.

5. A cartridge according to claim 1, wherein said discriminating member has a plate shape.

6. A cartridge according to claim 1, further comprising an operating portion operated by a user when said cartridge is mounted into or demounted from the main assembly,
wherein said discriminating member is provided at said operating portion.

7. A cartridge according to claim 1, wherein said discriminating member is marked with the discriminating information when said cartridge is assembled.

8. A cartridge according to claim 1, wherein said discriminating information is marked on a surface perpendicular to a direction in which said cartridge is mounted into or demounted from the main assembly.

9. A process cartridge detachably mountable to a main assembly of a color image forming apparatus for forming a color image on a recording material, said cartridge comprising:
an image bearing member on which a latent image is to be formed;
a developing unit including a frame for accommodating a developer and a developer carrying member for developing the latent image; and
a discriminating member molded of a material having a similar color to a color of the developer, wherein said discriminating member is marked with discriminating information for discriminating said cartridge.

10. A process cartridge according to claim 9, wherein the discriminating information is information indicating the color of said process cartridge.

11. A process cartridge according to claim 9, wherein the discriminating information is information indicating a destination of said process cartridge.

12. A process cartridge according to claim 9, wherein the material is a resin material.

13. A process cartridge according to claim 9, wherein said discriminating member has a plate shape.

14. A process cartridge according to claim 9, further comprising an operating portion operated by a user when said process cartridge is mounted into or demounted from the main assembly,
wherein said discriminating member is provided at said operating portion.

15. A process cartridge according to claim 9, wherein said discriminating member is marked with the discriminating information when said process cartridge is assembled.

16. A process cartridge according to claim 9, wherein said discriminating information is marked on a surface perpendicular to a direction in which said process cartridge is mounted into or demounted from the main assembly.
